(19) United States
(12) Patent Application Publication
(10) Pub. No.: US 2015/0217435 A1
(43) Pub. Date: Aug. 6, 2015

(54) IMPACT DRIVER ACCESSORY WITH INTERNAL TORSION ZONE AND METHODS OF MANUFACTURING SAME

(71) Applicant: kailash C VASUDEVA, Waterloo (CA)

(72) Inventor: kailash C VASUDEVA, Waterloo (CA)

(21) Appl. No.: 14/614,082

(22) Filed: Feb. 4, 2015

Related U.S. Application Data
(60) Provisional application No. 61/935,514, filed on Feb. 4, 2014.

(51) Int. Cl. B25B 23/00; B25B 21/02; B23P 15/00

(52) U.S. Cl. CPC B25B 23/0035; B23P 15/00; B25B 21/02

(57) ABSTRACT

An impact driver accessory, having a work portion and a shank, the shank has an axial hole at a distal end and the work portion has an engagement portion, the engagement portion is inserted in the axial hole and is secured in the axial hole, wherein there is a non-filled tubular section in the shank; A method of manufacturing an impact driver accessory, includes following steps, forming an axial hole at a distal end of the shank of a suitable length and inserting the engagement of the work portion in the axial hole and securing the engagement in the hole by one or more of a variety of mechanical mean, wherein there is a non-filled tubular section since the depth of the axial hole is longer than the length of the engagement of the work portion. The non-filled tubular section is serving as an torsion zone to withstand the large torsion.

### FIELD OF THE INVENTION

The invention relates to power driver accessory and methods of manufacturing same. In particular, the present invention relates to impact driver accessory, which can be used as impact drive bits or power bits and so on.

### BACKGROUND OF THE INVENTION

In conventional machine tools, such as hand operated tools, electric hand tools, numerical control (NC), machines computerized numerical control (CNC) machines, the tool drive accessory comprises a drive section (shank)) and a work section, wherein the drive section is held by the machine tool, and the work section is brought into contact with the component to be machined. It will be understood, however, that the term “machine tool” may be used to refer to any machine that provides a driving force for transmission to a machine tool bit. Thus, the term “machine tool” could also refer to devices driven by all kind of energy, such as diesel, steam, hydraulics, pneumatics, water, gas, electricity, battery or combinations thereof.

When an impact driver is utilized to drive fasteners, such as screws, into a work piece, a large driving torsion is generated in rapid cycles. Due to the large driving torsion, current power driver accessories often fail when used with impact drivers. This may be due to the fact that the power driver accessories often have a lower torsion rating than the torsion rating of the impact driver. It would be desirable to have a power driver accessory that can withstand the large torsion, especial the large torsion loading of an impact driver.

At present, most of the impact driver accessories are made out of one piece and impact or torsion zone is created by hatching various shapes, i.e. grooves and undercuts etc, on the shank.

As shown in US2009/0311061A1, an impact resistant tool is disclosed, it includes a shank and an active end, wherein the shank includes a pocket. A damping mechanism is positioned in the pockets to provide damping between the body and the shank during torque loading. The damping mechanism is of a shape memory material, e.g., a nitinol alloy. The cost is expensive because of the damping mechanism.

### SUMMARY OF THE INVENTION

It is an object of the present invention to provide an impact driver accessory with internal torsion zone and its manufacturing method, which may overcome some or all above problems.

In one aspect, the invention provides an impact driver accessory, comprising a work portion and a shank, the shank has an axial hole at a distal end and the work portion has an engagement portion, the engagement portion is inserted in the axial hole and is secured in the hole, wherein there is a non-filled tubular section in the shank.

The non-filled tubular section could be part of the axial hole, which is formed because the depth of the axial hole is longer than the length of the engagement portion.

The non-filled tubular section is a torsion zone, which can absorb the torsion force promoted by machine especially the impact machine, thus reducing the rigidity of the impact driver accessory by allowing some flexibility. Tests shows that the part of the shank with the non-filled tubular section can absorb torsion forces because the designed torsion zone provides a flex area that absorbs the torsion prompted by Impact Drivers.

Because of the built-in torsion zone, the impact driver accessory doesn't require special heat treatment or tempering as experienced on current impact driver accessory. It can also lower the cost of impact driver accessory because none or less exotic material is necessary. Therefore, the impact driver accessory can be used as a power bit or drive bit, especially used for impact tools.

Because the impact drive accessory is made of two piece and has the built-in torsion zone, the shank can be made out of standard steel, which doesn't need to be heat-treated or can be lower temperature heat treatment to 28/35R, while the work portion can be made out of different material, such as hard material. Those can bring the advantage of lower cost.

The torsion zone could have its internal and/or external profile helically twisted to enhance its torsion rating.

Furthermore, the invention also provided a double ended impact driver accessory, which comprising two work portions and a shank, the shank has two axial holes at both end and the two work portions respectively have an engagement, the engagements are respectively insert in one of the two axial hole and are secured in the holes, wherein, there is one or two non-filled tubular section on the shank.

The one or two non-filled tubular section could be part of one or two of the axial holes, which is formed because the depth of one or two of the axial holes is longer than the corresponding length of the one or two engagement.

Preferably, the sizes of two non-filled sections are different. Therefore, the double ended impact driver accessory can bearing different torsion.

A person skilled in the art will understand that the term “work portion” refers to the function and location of the portion of the impact driver accessories. In particular, the term “work portion” refers to the portion of the impact driver accessory adapted to be brought into contact with the component to be processed, for example, the component could be the head of screws.

The work portion may be provided with means for carrying out any suitable kind of work. For instance, the work portion may be provided with means for tightening or loosening of fasteners, drilling, tapping, milling, reaming or the like. The impact driver accessory could be wherein the accessory is a power bit, spade bit, nut setters, drill bit, socket drive extension, and so on.

The shank could be standard sized shank, such as shank used for 6 sides or 2 sides impact driver accessories. The shank may be of any suitable configuration. However, in a preferred embodiment of the invention, the shank comprises a drive shaft. A person skilled in the art will understand that the length of the drive shaft is not critical and, while the shape is also not critical, it is preferred that the drive shaft is polygonal, triangular, hexagonal or ovaloid shaped or trilobular.

To prevent the rotation of the work portion in the shank, it is prefer that the cross section of the axle hole is not round, for example, it could be ovaloid, hexagonal and so on; and the cross section of the engagement of the work portion accordingly is not round and it could be hexagonal, ovaloid shaped and so on. The diameter of the hole and the engagement are matching so that the hole can receive the engagement in a press fit mode and secures the work portion in the shank.

The engagement of the work portion can be secured in the shank by any means that is normally used in this area, for example, at least a portion of the shank is mechanically deformed to symmetrically compress the shank onto the engagement, for example by rolling, roll-peening, or differential expansion in heating and cooling. The engagement can also be secure in the shank by friction welding, welding and brazing. To enhance the secure, following a variety of means and designs may be employed to secure the work portion in the shank.

In one prefer embodiment, to secure the engagement in the hole, an angled portion on edge of the end of the shank is bent inward and locked in a groove with a certain depth, diameter and angle inward on the end of the engagement.

Specifically, the groove with certain depth, diameter and angle that bend inwards is formed on the end of the engagement of one or both work portion, accordingly an angled portion is on edge of the distal end of the shank. While the engagement is insert in the shank, the angled portion is bent inward and locked in the groove.

In another preferred embodiment, at least a portion of engagement of the work portion has ribs, and the shank is compressed tightly against the engagement of the work portion, therefore, radial rotation of the engagement in the hole of the shank can be avoided.

In another further preferred embodiment, at least initial part of end portion of the engagement has no rib to ensure accurate engagement of the work portion into the hole.

In other aspect, the invention provides an impact driver accessory manufacturing method, said bit includes a work portion and a shank, the method includes steps of forming an axial hole at a distal end of the shank of a suitable length and inserting the engagement of the work portion in the axial hole and securing the engagement in the hole, wherein a non-filled tubular section is formed because the depth of the axial hole is longer than the length of the engagement of the work portion.

Furthermore, the invention also provided a manufacturing method of double ended impact driver accessory, the double ended impact driver accessory comprising two work portions and a shank, the method includes steps of forming two axial holes at both ends of the shank of a suitable length and respectively inserting the engagements of both work portions in each axial hole and securing the engagements in the holes, wherein a non-filled sections are formed on both sides because the depth of the axial holes are longer than the length of the engagements of both work portions.

Right now, impact tool bit is made of one piece, which is mastery machine and then heat-treated. During the heat-treatment process, the tool bit can easily be deformed because of the long length. But for the manufacturing of the impact driver accessory of this application, only the work portion need to be heat processed and the work portion can be of a length of not greater than ⅞″, therefore, deforming during the heating process can be avoid. Therefore, the method in our invention can lower the cost and improve yield.

To secure the engagement of the work portion in the hole of the shank, means that is normally used in this area can be used, for example, at least a portion of the shank is mechanically deformed to symmetrically compress the shank onto the engagement, for example by rolling, roll-peening, or differential expansion in heating and cooling. The engagement can also be secure in the shank by friction welding, welding and brazing. Or the shank is cold heading or cold forming. To enhance the secure, following a variety of means and designs may be employed to secure the work portion in the shank.

Furthermore, because only the work portion needs to be heat treated, the cost of the manufacturing is decreased. The double ends impact driver accessory can also lower the cost because with two bits, only one shank is needed.

Additional features of the invention will be described or will become apparent in the course of the following detailed description.

### BRIEF DESCRIPTION OF THE DRAWINGS

The invention will now be described in detail, with reference to the accompanying drawings by way of example only, in which:

FIG. 1 is a side view of first example of impact bit according to the invention;

FIG. 2 is a partially sectioned side view of the impact bit according to FIG. 1;

FIG. 3 is a exploded view of an impact bit according to FIG. 1;

FIG. 4 is a partially sectioned side view of FIG. 1;

FIG. 5 is a sectioned view of a variation of unlocked tool bit to show secure;

FIG. 6 is side view of locked tool bit as in FIG. 5;

FIG. 6A is a side view of the tool bit with a external twisted torsion zone;

FIG. 6b is a section view of tool bit in Fig .6A showing internal twisted torsion zone;

FIG. 7A and FIG. 7B is side view and end view of work portion with ribs;

FIG. 8A and FIG. 8B is side view and end view of work portion with ribs.

FIG. 9A is a side view of another example of impact bit with double ends.

FIG. 9B is an end sectioned view of the impact bit from line B-W;

FIG. 9C is partially sectioned side view of the impact bit according to FIG. 9A;

### DETAILED DESCRIPTION

The following description and figures illustrates our impact driver accessory in the form of an impact bit. But it could be understood that our invention does not limit to impact bits, namely, the working portion could be any shape and the impact driver accessory could be any driver accessory or tools, such as nut setters, socket driver, spade bit and so on.

### 1. Impact Bit

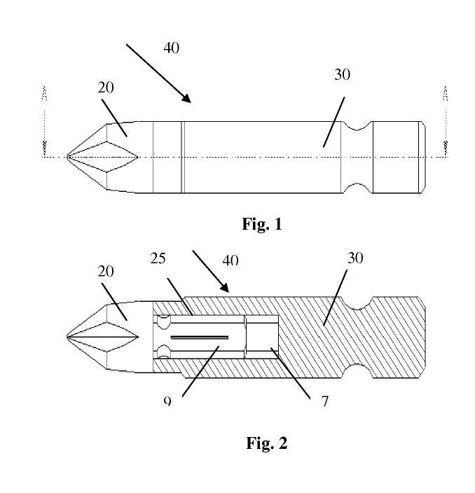

As shown in FIGS. 1-4, an example of the impact bit 40 of the application has a work portion 20 and a shank 30. The work portion 20 is secured in the axial hole 25 in the distal end of the shank 30.

The work portion 20 has a tip 22 and an engagement 9. The shape of the tip 22 can be changed according to usage.

The shank 30 has an axial hole 25 at the distal end. The engagement 9 is insert in and secure in the hole 25. Because the depth of the hole 25 is longer than the length of the engagement, a non-filled tubular section 7 is formed after engagement 9 is insert in the hole 25.

The depth of the non-filled tubular section 7 can be adjusted, for example, the length of the non-filled tubular section 7 could be up to 6 times of the diameter of the shank, preferably, it could be 1.5 to 2 times of the diameter of the shank.

The non-filled tubular section 7 is a torsion zone, which can absorb the torsion force promoted by machine especially the impact machine, thus reducing the rigidity of the tool bit by allowing some flexibility.

The non-filled section work as a built-in torsion zone, therefore, the impact bit doesn't require special full body heat treatment or tempering as experienced on current tool bits.

The impact bit can be made with only the work portion being high-heat treated. Therefore, the shank and the work portion can be made out of different material. For example, the shank could be made of standard hex steel, which is no heat treated or lower heat treated to 28/35 Rc, while the work portion can be made of hard steal, such as heat treated to 55/62 Rc, S2 steel, V5 steel (Which is made by the China Steel Cooperation, Taiwan), or chrome vanadium material, and so on. It can also lower the cost of impact bits or drive bits because none exotic material is necessary.

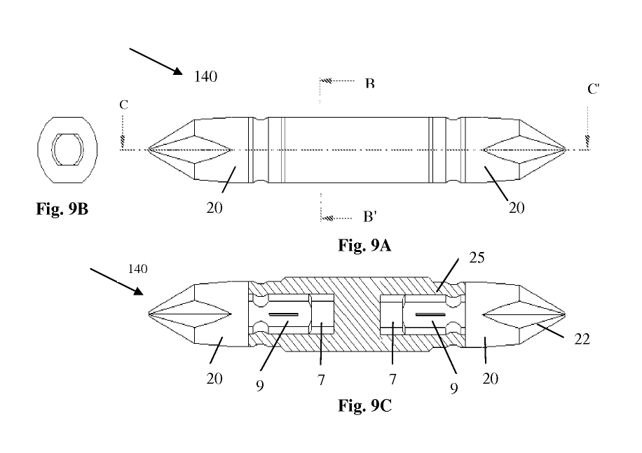

As shown in FIGS. 9A, 9B and 9C, another example of the impact bit includes double ends bit. The double ends impact bit 140 of the application has two work portions 20 and a shank 30. The work portions 20 are secured in two axial holes 25 on both ends of the shank 30. Each work portion 20 has a tip 22 and an engagement 9. The shape of the tip 22 can be different according to usage.

The shank 30 has two axial holes 25 in the both ends. Both engagements 9 of both work portions are inserted in and secured in the holes 25. Because of the depth of the holes 25 are longer than the length of the engagements 9, a non-filled tubular section 7 on both ends is formed while engagement 9 is inserted in the hole 25.

The depth of the non-filled tubular section 7 can be adjusted, it could be up to 6 times of the diameter of the shaft; preferable, the length of the non-filled tubular section is 1.5 to 2 times of the diameter of the shank. The depths of the two non-filled sections 7 can also be different.

Following are different embodiments of the different designs to secure the work portion on the shank. All the embodiment are shown with one work portion impact bits, but all the embodiments can also work on the double ends impact bits.

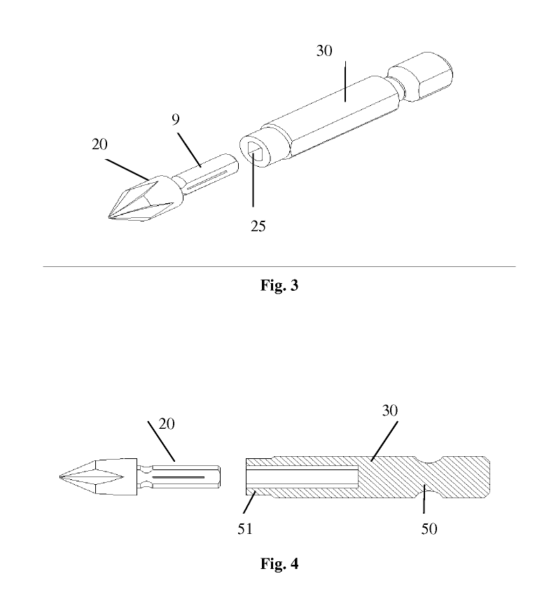

As shown in FIG. 3, the shank has a cross section of ovaloid shaped, the shape other than ovaloid could also be used i.e. Hexagonal or any polygonal shaped.

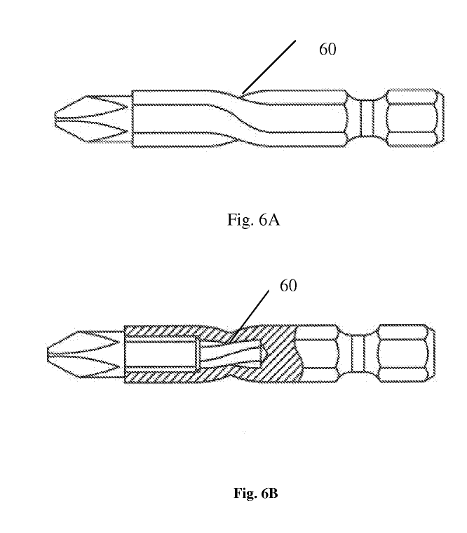

As shown in FIG. 6A-6B, the portion of the torsion zone 60 could be twisted.

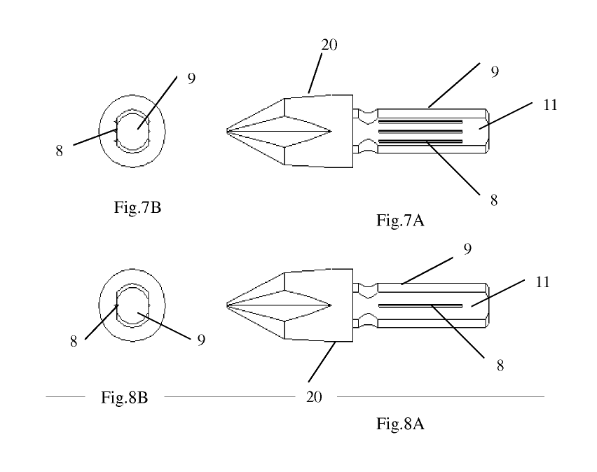

As shown in FIGS. 7A-7B, the engagement 9 has a crossed section shape of Ovaloid, accordingly, the axial hole 25 has a cross section shape of ovaloid. This shape can prevent the engagement from rotating in the hole, so as to enhance the secure. Other noncircular shape can also works, such as hex or polygonal. The size and the shape of the engagement and the hole are matched, to that the engagement can be press-fit in the hole.

The engagement of the work portion can also be secured in the shank by the means that is normally used in this area, for example, at least a portion of the shank is mechanically deformed to symmetrically compress the shank onto the engagement, for example by rolling, roll-peering, or differential expansion in heating and cooling. To enhance the secure, a variety of means and designed may also be employed to secure the work portion in the shank.

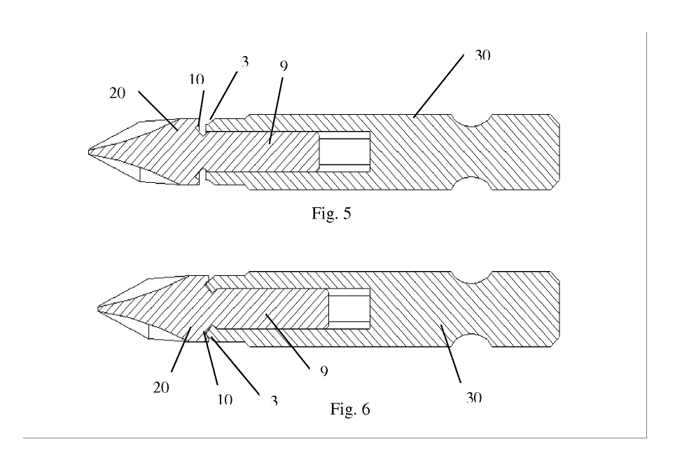

In one embodiment, as shown in FIG. 5-6, for secure the engagement in the hole, an angled portion on edge of the distal end of the shank is bent inward and locked in a groove with a certain depth, diameter and angled inward on the engagement. Specifically, for axially capture or secure the work portion 20 in the shank 30, a groove 10 with a certain depth, diameter and angle that bend inwards are formed on the engagement portion 9. The groove 10 is on the end of the engagement that is close to the tip, accordingly an angled portion 3 is on edge of the distal end of the shank 30, while the engagement is inserted in the shank, the angled portion 3 is bent inward and locked in the groove 10. Since the shank can be made out of standard steel, it is not as hard as the work portion, therefore, the angled portion 3 can be deformed and press fit in the groove 10 so as to secure the work portion in the shank.

In the preferred embodiment, illustrated in FIGS. 7-8, a section of the engagement of work portion is provided with ribs 8. Preferably, a lead-in portion 11 immediately adjacent the proximal end is not ribbed, to facilitate starting the work portion into the axial hole and to ensure proper concentricity as it is inserted in the hole. The shape of the ribs 8 can be in different form, as shown in FIGS. 7-8. The engagement 9 has a crossed section shape of ovaloid, it is preferably that the ribs is on the flat surface.

### 2. Method of Manufacturing the Bits

Refer to FIGS. 1-4, the method of manufacturing the impact bit of the invention, includes following steps, the shank of a suitable length is formed with an axial hole at a distal end, providing a work portion with engagement, the engagement 9 of the work portion 20 is inserted into the axial hole 25 and is secured in the hole, because of the depth of the hole 25 is longer than the length of the engagement and the hole has a non-filled tubular section 7 while engagement 9 is insert in the hole 25.

Refer to FIGS. 9A, 9B and 9C, the method of manufacturing of the impact bit with double ends of the invention, includes following steps, a shank of a suitable length is formed with two axial hole at both end, providing two work portions with engagement, the engagements 9 of both work portion 20 are respectively insert into the axial holes 25 and are secure in the holes, because of the depth of the holes 25 are longer than the length of the engagements and a non-filled tubular section 7 formed in each hole 25 while engagement 9 is inserted in each hole 25.

The length of the non-filled tubular section 7 could be up to 6 times of the diameter of the shank, preferably, it is 1.5 to 2 times of the diameter of the shank.

Shanks are cut from a cross section ovaloid shaped or standard hex shaped bars, for example using a high-speed saw, a single-spindle machine or a press standard lengths.

Optionally, the cut shafts are placed in a tumbler and processed to eliminate burrs and sharp edges. The cut shafts are then loaded into a hopper or vibratory bowl feeder and fed into a combination chamfering/notching machine, which automatically loads and chucks each shaft in turn for machining. Two circumferential grooves 50 and 51 are formed on the shafts in this machine, wherein the circumferential groove 51 is on distal end of the shank. The circumferential groove 50 is optional, but is a “standard” feature of many tool bit. If present, the circumferential grooves should be made according to ANSI/ASME standards (B107.4M-1995).

The shank 30 is formed with one axial hole 25 on one end or two axial holes 25 on both ends. The method to form the hole 25 could be any method used in this area. For example, it could be cold forming or cold heading. Optionally, it could also be formed by drilling or gun drilling operation, or spot/centre-drilling.

Thereafter the bottom portion (torsion zone) of the axial hole 25 could be formed/machined having a twisted helix profile 60 by a cam punch, as shown in FIG. 6A-6B. Furthermore, the external profile of the shank 30 at torsion zone can me machined with a helical twist to complement the inner twist. Alternatively this portion can be induction heated and mechanically twisted to form inner and outer helix simultaneously. The twist can be right handed or left handed.

The portion of shank 30 at non-filled tubular section 7 could also be heat treated locally in order to further enhance the springiness/elasticity for torsion enhancement, for example, the heat treatment is to 55-58 RC.

The working portion could be made by cold forming the working tip. Before or after the cold forming, an engagement portion is formed and the engagement is fed into another forming machine to form ribs on at least part of the engagement. The working portion could made of any readily available material used for impact bit, such as S2 material, modified S2 steel and V5 Steel (developed by China Steel Corporation, Taiwan). The material could be chosen according to the required hardness, thus eliminating the need for expensive heat treatments.

The shape of the ribs on the engagement can be different as shown in FIGS. 7A and 8A.

More specifically, at least initial part of end portion of the engagement has a non-rib portion 11 as in FIG. 7A-7B to ensure accurate engagement of the work portion into the hole.

Preferably, the method include the step of forming a groove of certain depth, diameter and angle that bend inwards on the end of the engagement of the work portion, and the step of forming accordingly an angled portion on edge of the distal end of the shank. While the engagement is insert in the shank, the angled portion is bent inward and is locked in the groove 10, which serve as an axial lock mechanism and depth register so as to secure the engagement in the hole.

Steps of forming the groove 10 on the engagement and the angled portion 3 on the shaft can be carried out with notching machine. The steps can be before the heat treatment of the work portion and the shank.

The engagement 9 of the work portion 20 is inserted into the axial hole 25 and is secure in the hole by normal technical means. Preferably, the size and shape of the axial hole 25 is preferably sized to an optimum diameter for press-fitting the engagement in the axial hole. As an example, the engagement is cooled and the shank is heated to certain temperature to get certain expanded, then the engagement is insert in the axial hole and locked in the hole while the shank is cooled down. The temperature of cooling and heating can be adjusted according to the thermal expansion coefficient of the raw material and it can be decided by routine tests. Further, other mechanical means, such as rolling can also be used on the shank after inserting.

The above description relates to preferred embodiments by way of example only. However, it should be apparent to those knowledgeable in the field that many variations are possible, without departing from the spirit of the invention. Such variations are intended to be within the scope of the invention as claimed, whether or not expressly described above.

Variations can be following : drills for impact application with or without torsion area can also be made by the method in the application; for some applications, method of joining can be friction welding, welding and brazing; the impact drive accessory is a power bit, spade bit, nut setters, drill bit, or socket drive extension.

1. An impact driver accessory, having a work portion and a shank, the shank has an axial hole at a distal end and the work portion has an engagement portion, the engagement portion is inserted in the axial hole and is secured in the axial hole, wherein there is a non-filled tubular section in the shank.

2. An impact driver accessory as in claim 1, wherein the non-filled tubular section is part of the axial hole, which is formed because the depth of the axial hole is longer than the length of the engagement portion.

3. An impact driver accessory as in claim 1, wherein there is another work portion and the shank has another axial hole at other end, the engagement portion of another work portion is insert in the another hole.

4. An impact driver accessory of claim 1, wherein the length of the non-filled tubular section is up to 6 times of the diameter of the shank.

5. An impact driver accessory of claim 1, wherein the length of non-filled tubular section portion is locally heat treated from inside and/or externally.

6. An impact driver accessory of claim 1, wherein the profile of non-filled tubular section portion is helically twisted from inside and/or outside.

7. An impact driver accessory of claim 1, wherein the hole is polygonal, triangular or ovaloid shaped and the engagement of the work portion accordingly is polygonal, triangular or ovaloid shaped.

8. An impact driver accessory of claim 1, wherein the engagement at least partly has ribs.

9. An impact driver accessory of claim 8, wherein at least initial part of end portion of the engagement is not ribbed to ensure accurate engagement of the work portion into the hole.

10. An impact driver accessory of claim 1, wherein to secure the engagement in the hole, an angled portion on edge of the distal end of the shank is bent inward and locked in a groove with a certain depth, diameter and angled inward on the engagement.

11. An impact driver accessory of claim 1, wherein the accessory is a power bit, spade bit, nut setters, drill bit, or socket drive extension.

12. A method of manufacturing an impact driver accessory, said bit includes a work portion and a shank, the method includes following steps, forming an axial hole at a distal end of the shank of a suitable length and inserting the engagement of the work portion in the axial hole and securing the engagement in the hole by one or more of a variety of mechanical mean, wherein there is a non-filled tubular section since the depth of the axial hole is longer than the length of the engagement of the work portion.

13. The method of claim 12, wherein, the bit includes another work portions, the method includes forming another axial holes at other end of the shank and inserting the engagement of another work portion in the another hole.

14. The method of claim 12, wherein the method includes the step of forming an groove with certain depth, diameter and angle that bend inwards on the end of the engagement, and the step of forming accordingly an angled portion on edge of the distal end of the shank.

15. The method of claim 12, wherein the method includes the step of forming ribs on the engagement before insert the engagement in the hole.

16. The method of claim 12, wherein the work tip of the work portion is formed by cold forming before or after the ribs is formed on the engagement.

17. The method of claim 12, wherein the engagement is be secure in the shank by at least a portion of the shank being mechanically deformed to symmetrically compress the shank onto the engagement by rolling, roll-peening, or differential expansion in heating and cooling.

18. The method of claim 12, wherein the shank is heated and the engagement portion is cooled before inserting the engagement in the hole.

19. The method of claim 12, wherein work portion is made of the material of S2 steel, V5 steel material or chrome vanadium material.

20. The method of claim 12, wherein the hole is formed by cold forming, drilling or gun drilling or broaching.
